(19) United States
(12) Patent Application Publication
(10) Pub. No.: US 2010/0145615 A1
(43) Pub. Date: Jun. 10, 2010

(54) Measuring and mapping receiver performance using global positioning system (GPS)data

(76) Inventors: Christopher L. McCrank, Austin, TX (US); Joshua Caskey, Austin, TX (US)

Correspondence Address: TROP, PRUNER & HU, P.C., 1616 S. VOSS ROAD, SUITE 750, HOUSTON, TX, 77057-2631, US

(21) Appl. No.: 12/315,935

(22) Filed: Dec. 8, 2008

(51) Int. Cl. G01C 21/30; G01S 1/00

(52) U.S. Cl. 701/213; 342/357.06

(57) ABSTRACT

In one embodiment, a method for performing testing of a receiver is provided. The method may include recording performance data associated with a radio signal received by a receiver, and recording global positioning system (GPS) data, where the GPS data is obtained from a GPS receiver co-located with the receiver. Then this data may be processed to map the performance data with the GPS data to indicate at least a location of the receiver and a corresponding receiver performance metric.

### BACKGROUND

Broadcast receiver performance is highly dependent on location-specific phenomena, such as multipath reflection due to buildings, signal fading due to terrain, or blocking/jamming due to other transmitters. As such, performance can be dramatically affected in mobile applications such as receivers of a vehicle sound system, mobile receivers incorporated in portable devices, and so forth.

Currently, to test a mobile system a vehicle including the system is driven, possibly though challenging areas so that audio output quality can be judged. Thus testing is very subjective. At most, the system output may also be recorded for later playback. However, there is no indication of geographical conditions when bad reception occurs. Thus simply recording resulting audio and listening to it later suffers from drawbacks including subjectivity and providing little correlation to a location that might have caused adverse performance. For example, a test recording may only reveal a half second of fuzzy sound but provide no indication of reasoning for the adverse performance. Still further, options for test repeatability are virtually non-existent due to the lack of available data. Accordingly, current test applications for a broadcast receiver, particularly in a mobile environment, are limited.

### SUMMARY OF THE INVENTION

One aspect of the present invention is directed to a method for performing testing of a receiver. The method may include recording performance data associated with a radio signal received by a receiver, and recording global positioning system (GPS) data from a GPS receiver co-located with the receiver. Then this data may be processed to map the performance data with the GPS data to indicate at least a location of the receiver and a corresponding receiver performance metric. Additional information associated with the signal may be obtained, such as a recording of the radio signal and/or additional performance data obtained from test equipment. After processing, information regarding the data may be displayed. In one manner, the display may provide a map view of an area in which the receiver was traveling and indicators to identify locations within the area at which the performance data was recorded. By selection of an indicator, at least part of the performance data for the corresponding location and synchronized playback of an audio signal obtained may occur.

Yet another aspect of the present invention is directed to a system including a receiver, a GPS receiver, and a computer system. The receiver receives a radio frequency (RF) signal and converts it into a demodulated signal and generates performance data regarding the RF signal. The computer system is coupled to the receiver and the GPS receiver to receive the performance data and GPS data obtained during traversal of a route on which the receivers travel. The system can then process the data to map the performance data with the GPS data to indicate at least a location of the receiver and a corresponding receiver performance metric from that location.

A still further aspect of the invention is directed to a system that includes a processor to execute instructions and a storage medium including the instructions. Such instructions may enable the system to receive performance data from a receiver coupled to the system and GPS data from a GPS receiver coupled to the system, the data obtained during traversal of a route on which the receivers travel, associate the performance data with the GPS data, generate entries each including the GPS data and the performance data for a data acquisition point along the route, and enable display of the route and selectable markers, each of the selectable markers to display data obtained and to synchronize audio playback from the corresponding data acquisition point.

### BRIEF DESCRIPTION OF THE DRAWINGS

FIG. 1 is a block diagram of a testing system in accordance with one embodiment of the present invention.

FIG. 2 is a flow diagram of a method for performing testing in accordance with an embodiment of the present invention.

FIG. 3 is a screen view of a mapping application in accordance with an embodiment of the present invention.

FIG. 4 is a graphical view of a text box that may be displayed upon selection of a selectable icon on a display in accordance with one embodiment of the present invention.

### DETAILED DESCRIPTION

Embodiments provide a qualitative, intuitive, and repeatable method of quantifying, storing and visualizing receiver performance. Combining performance metrics of a receiver, data obtained from a global positioning system (GPS) receiver such as time and coordinate information, and a tool to visualize the results can enable efficient measuring, quantifying, interpreting and re-creating of receiver performance. In this way, specific events, such as audio interruptions, pops, clicks and so forth can be ascribed to a known geographic location and corresponding conditions. For example, using a test method in accordance with an embodiment of the present invention may reveal that an undesirable audio effect such as “fuzz” was created while driving under an overpass in a specific direction at a specific speed.

Embodiments may be used to benchmark receiver products against competitors and/or quantify performance deltas as changes are made to a product. For example, performance results may be recorded using a receiver programmed with different firmware or other control algorithms. This allows different solutions to be compared by tracking the same route with different receiver products. Further, by recording and cataloging data for later analysis, several different measurements can be made on different products or at different times. The results then may be analyzed at a later date.

In one embodiment, various components may be interconnected to enable measurement and processing of received radio frequency (RF) signals and GPS data. In one implementation a testing system may include a device under test (DUT), which may be a broadcast, satellite, or short-range wireless receiver, such as an audio tuner formed as a single chip tuner that may be configured for use within a portable device such as a portable media device, mobile Internet device, cellular telephone, vehicle sound system, or so forth. For purposes of overall discussion herein, an example of an audio tuner is used, however the scope of the present invention is not limited in this regard.

Output parameters that can be obtained may include a resulting signal-to-noise ratio (SNR), received signal strength indication (RSSI), stereo/mono blend and so forth. The tuner may include various mechanisms to measure the signal quality parameters. Such mechanisms include signal detection mechanisms, signal strength mechanisms and various processing that can be performed by an on-chip digital signal processor (DSP) to generate various information regarding performance of the receiver. Such information may be stored temporarily in a storage of the single chip tuner such as a flash memory, register space or so forth. Under control of signals received from a control utility of a computer system of the testing system, such performance data may be provided to the computer system. As will be described below, this performance data can be sent to the computer via a software logging utility.

In addition, resulting audio obtained from the audio tuner can be recorded in an audio recording device and time-stamped to synchronize with location information. In addition, some embodiments may include test equipment to measure signal parameters. For example, a spectrum analyzer may be used to record the field strength of the received signal. The spectrum analyzer or other RF test equipment may be coupled to a calibrated antenna to obtain a calibrated ambient field strength measurement, e.g., as measured in micro-volts per meter. Or a modulation analyzer can be used to obtain information about a broadcast signal.

The testing system may further include a GPS receiver. This GPS receiver may be a standalone receiver, or it can be within the same portable device as the audio tuner. In any event, for purposes of testing the GPS receiver is co-located with the audio tuner. For example, the audio tuner and GPS receiver may be placed in a vehicle (or possibly on foot, in a backpack) to be transported around a test route.

During data acquisition, the system may be controlled to periodically record information from the audio tuner and the GPS receiver. For example, location, time, speed, heading, and the data of interest can be obtained on a regular basis (e.g., every second or other appropriate interval). In one embodiment, a logging application may periodically obtain data to provide a complete system snapshot. More specifically, for each sampling instance, data from the GPS data is interleaved with the performance data so that a full picture at an instant in time and a given location can be realized. This information includes the GPS data obtained from the GPS satellite and performance data obtained from the receiver for that location. The logging application may generate entries for each time instant, including the GPS data and the performance data, which may be obtained from the DUT and the test equipment. While the data may be maintained and accessed in tabular (e.g., spreadsheet) form, embodiments provide for the ability to visualize this snapshot data via a display application, as described below.

The testing system may further include a computer and associated software to control the DUT, measurement equipment, GPS module, and store a file with the resulting data. The computer may operate to format data into a format usable with a display or visualization application, e.g., mapping software such as the markup language format .kml used for Google™ Earth™ mapping software. Once all data is collected, the software saves a file in a format to be opened directly in a mapping/display application. Thus using mapping software or a geographic information system (GIS) package, post analysis and display of the data can be realized. In other embodiments a dedicated microcontroller-based platform may be used, and which may also generally be referred to herein as a computer system.

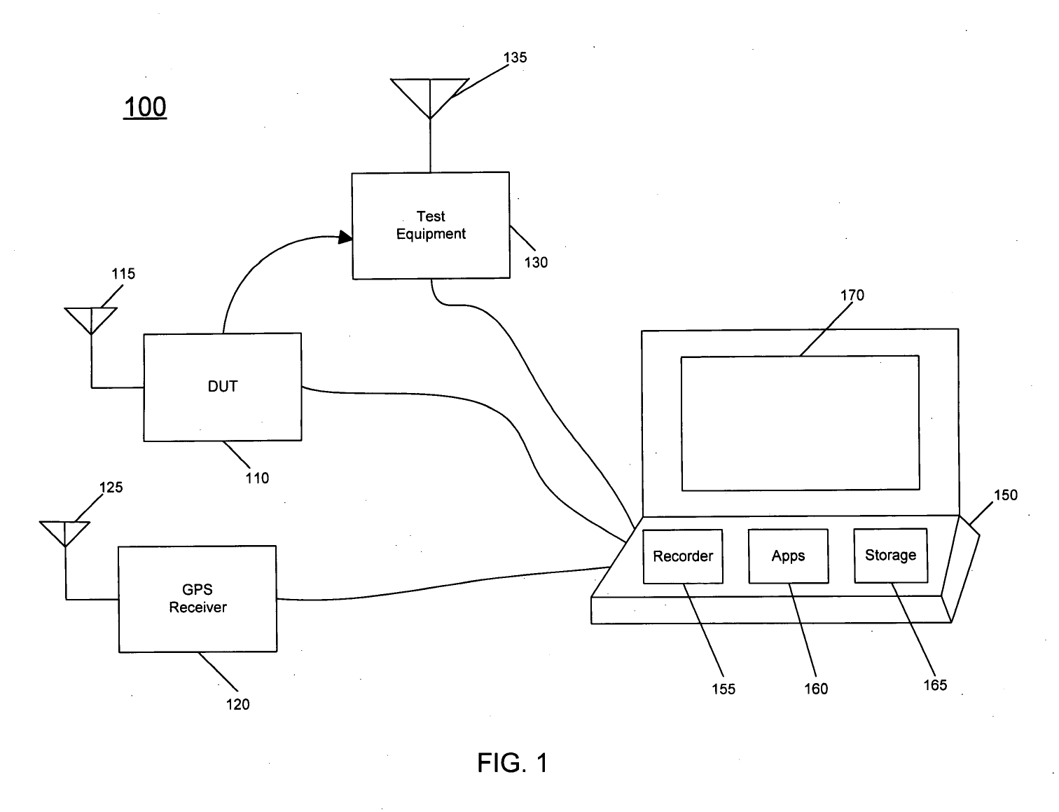

Referring now to FIG. 1, shown is a block diagram of a testing system in accordance with one embodiment of the present invention. As shown in FIG. 1, system 100 may include various components coupled to a computer system 150. In various embodiments, system 150 may be a personal computer such as a desktop, laptop, or so forth having typical components such as processor, memory, chipset components, storage media, and so forth. Since testing may be performed in a mobile environment, in implementations in which the computer system is not portable, embodiments may further include a remote recorder to enable the recording of various information from the different components, which can then be later downloaded from the remote recorder to the computer system. For example, a dedicated microcontroller platform may include ports to enable interconnection to the test components, a processor, and one or more storage media to store data and programs for execution.

As shown in FIG. 1, the components from which data may be obtained include a DUT 110. DUT 110 may be a broadcast radio tuner such as a single chip semiconductor device. Because many implementations may be used during testing and evaluation of a tuner before DUT 110 is incorporated into a finished product such as a given sound system, DUT 110 may be configured on an evaluation board or other test platform. Thus embodiments apply to a tuner in various stages of development, or where the tuner is incorporated in a finished product or is a finished product. As shown, DUT 110 is coupled to an antenna 115. The output from DUT 110, which corresponds to demodulated data, may be provided to system 150, and more particularly to a recorder 155 within system 150 that records the demodulated data, which may be audio data in many instances (although other data, such as radio data system (RDS) data may also be obtained). Recorder 155 may be a dedicated recorder to store incoming audio data into a storage of the computer. Alternately, the recorder may be implemented via a software application. In yet other embodiments, a sound card of the computer system may be used to receive audio data via an external port of the computer and convert the audio data into a computer-readable format for later playback. In addition, various information such as performance indicators which may be obtained from different registers or other performance monitors of DUT 110 may further be provided to system 150.

In various implementations, system 150 may include one or more applications 160 configured to control obtaining of data from the above components, log performance data, and store it in a storage medium 165. Applications 160 may be implemented in code and may be stored on storage medium 165 having stored thereon instructions which can be used to program a system to perform the instructions. The storage medium may include, but is not limited to, any type of machine-readable storage medium to enable storing and accessing of electronic instructions.

Similar logging of information from a GPS receiver 120 may also be performed by applications 160. As shown, GPS receiver 120, which may be a portable GPS receiver, may be coupled to an antenna 125. Applications 160 may be configured to record GPS data, including time, location, direction and heading on a predetermined interval. Note that in implementations in which DUT 110 is integrated into a finished product such as a portable device, it is possible that both GPS receiver 120 and DUT 110 are configured within the same device.

Still further, in some implementations a test equipment 130 may further be coupled to receive incoming RF signals via an antenna 135, and provide processed information to system 150. As an example, test equipment 130 may be a spectrum analyzer that is configured to independently receive the RF signal and determine various characteristics of the signal, such as its strength or quality. In this way, an independent evaluation, separate from the DUT 110, can be provided. By using a calibrated antenna 135 to quantify accuracy of tuner measurements, changes can be made to an RF matching circuit on the front end of the audio tuner to attempt to more closely match the tuner (i.e., DUT 110) with its antenna. As seen, in certain implementations, an output of DUT 110, e.g., a demodulated signal, may be provided to test equipment 130. In other embodiments, any sort of lab test equipment such as may be under GPIB, USB, or RS232 control can be provided. For example, a voltmeter measuring voltage on a node of an attenuator circuit, an ammeter measuring supply current to the DUT, an oscilloscope measuring signal swing or frequency, or so forth may be present. Such equipment may be used to measure a variety of different electrical quantities in real time while performing a test. In addition, another type of equipment may be an audio analyzer to measure SNR or distortion at the audio output. This is useful when measuring a device of a third party in which there is no access to internal nodes or parameters.

When all the desired data has been obtained and logged, applications 160 may process the data into an appropriate format for use. As one example, a file generator may format the data, including providing a set of tags to the input data to generate a file that can be then used by a given application such as mapping software such that the data can be visualized on a display 170, along with mapping information of the route traversed during the data acquisition. Embodiments may further associate the GPS and performance data, and further synchronize the audio recording obtained to the GPS and performance data. In this way, when analyzing the data from the recording, a user can actually fast forward to the actual portion of the audio stream that corresponds to a location on the traveled route, as indicated on the display. While shown with this particular implementation in the embodiment of FIG. 1, the scope of the present invention is not limited in this regard.

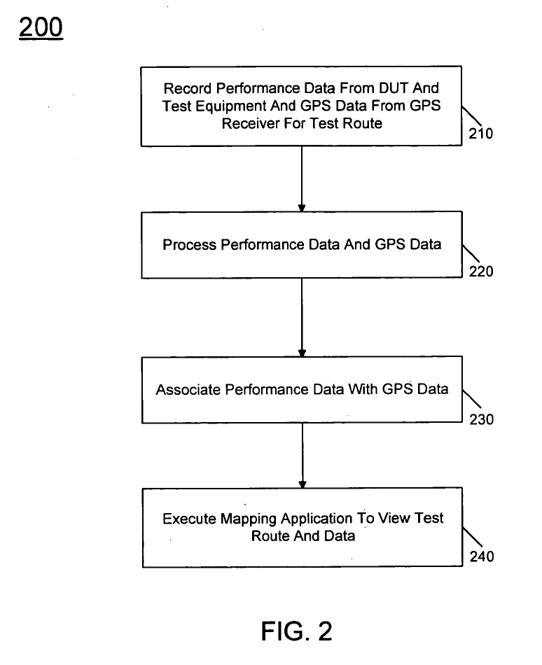

Referring now to FIG. 2, shown is a flow diagram of a method for performing testing in accordance with an embodiment of the present invention. As shown in FIG. 2, method 200 may be implemented by one or more applications executing on a system to acquire data during traversal of a test route and then to process and subsequently review the data. As shown in FIG. 2, method 200 may begin by recording performance data for various equipment, as well as recording of GPS data from a GPS receiver (block 210). This data may be obtained in real time under control of a control utility which sends signals to the receivers in order to select receiver parameters, and obtain the desired data.

As discussed above, such equipment may include one or more devices under test, one or more pieces of test equipment that provides additional (or at least independent) performance data, in addition to the GPS receiver that provides GPS data. Note further that in some implementations in addition to performance data, actual audio or other demodulated data output by the DUT may also be recorded. In some embodiments, rather than audio data, the demodulated data may be non-audio data such as RDS data such as may be used for a traffic message channel or information about radio stations. In some embodiments, rather than logging the actual RDS data, the RDS data as converted into a readable format may be logged so it can be displayed or reviewed. Such recording can be via a stand alone recorder or by way of a recorder of a logging system.

Next, the performance data and the GPS data may be processed (block 210). Such processing may be post processing performed after completion of data acquisition, in some embodiments. For example, various processing such as normalization, equalization and so forth may be performed. In addition, the data may be placed into a format for use with a given mapping application, e.g., via incorporation of tags with the data. Furthermore, the performance data may be associated with the GPS data (block 230). For example, a single file may be generated that includes both the performance data and the GPS data. In this file, for each data acquisition point, the corresponding GPS and performance data may be associated. In addition, the demodulated data can be synchronized with the other data, such as by way of time stamps.

Finally, method 200 may be used to execute a mapping application to view the test route and the data (block 240). In one implementation, the display may include a map with the current location, an audio snapshot of data recorded around that location and performance data obtained at that location, and potentially data from a calibrated instrument, also obtained at that location. Note that the audio data may be synchronized with respect to the other data. In addition to a review of the test route undertaken, the performance data may also be displayed via a sidebar or, e.g., via selectable indicators such as flags or so forth.

In one implementation, the selectable markers may be continuously color coded to identify relative strength of a given parameter. For example, for SNR analysis a blue color may be used to identify values close to the zero scale and other colors, e.g., red, can identify values close to the top end of the scale. In addition, different icon shapes and sizes may also be used to identify relative strength of various parameters. In this way, a table of information can be displayed for any selected data point to identify the various performance data obtained at that data point. From this, a user may be able to determine the geographical conditions present at a given data acquisition point. In some embodiments, a recorded audio file can be synchronized to location information. As an example, the mapping application may provide a synchronization mechanism that is activated by selection of a selectable marker. By user selection, playback of the audio file may jump to that point in time corresponding to the marker location.

In some test implementations, multiple DUTs may be provided to enable comparison testing, either between two separate radio stations like a strong station and a weak station as obtained by identical receivers, or between two different tuner products, such as competing products, or a single product differently configured, such as with two different firmware implementations. In various embodiments, a user can choose what parameters to compare between different DUTs, e.g., by use of a user interface. After file generation the information can be visualized using a selected graphics application.

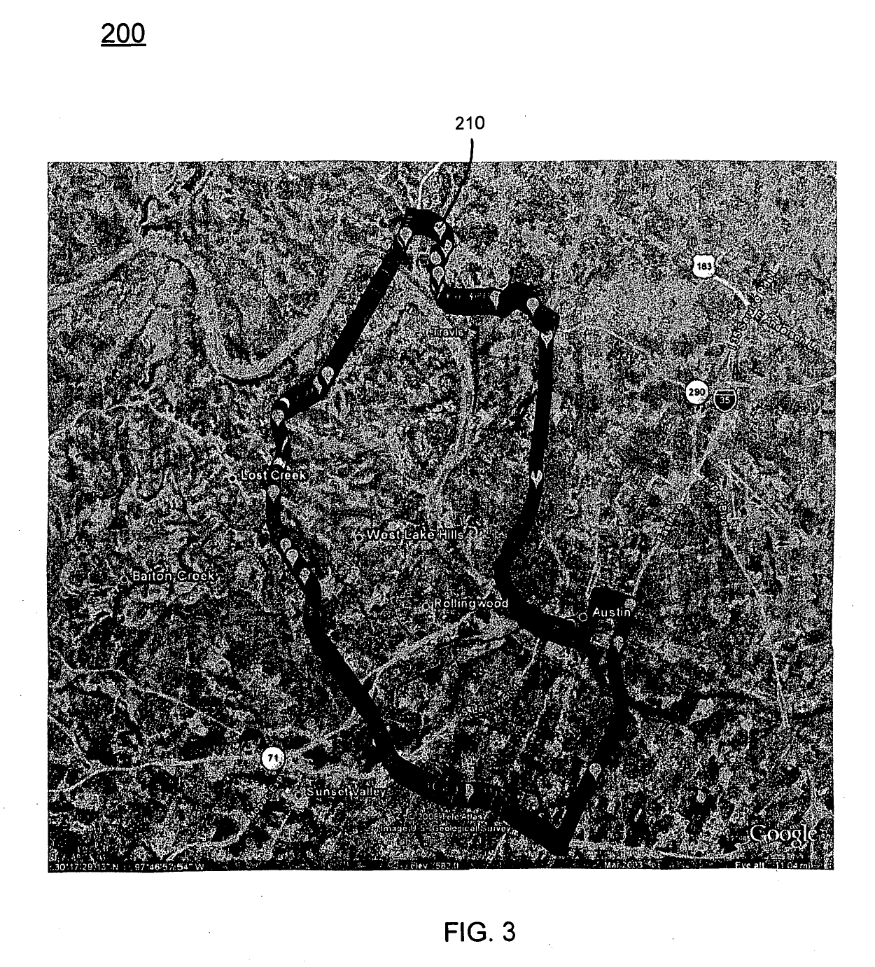

Referring now to FIG. 3, shown is a screen view of a mapping application in accordance with an embodiment of the present invention. As shown in FIG. 3, map view 200, which may be shown on a display of a computer system of a testing system, includes a map of a general area in which a test route was taken. In the embodiment shown in FIG. 3, the test route is shown to encompass a route around the Austin, Tex. metropolitan area. As seen, along the route a large number of selectable icons 210 are shown. Understand that in a given implementation each selectable icon may represent a data acquisition point along the route. Also understand that in various implementations these selectable icons may be color coded to identify a relative strength of one or more parameters of the performance data obtained.

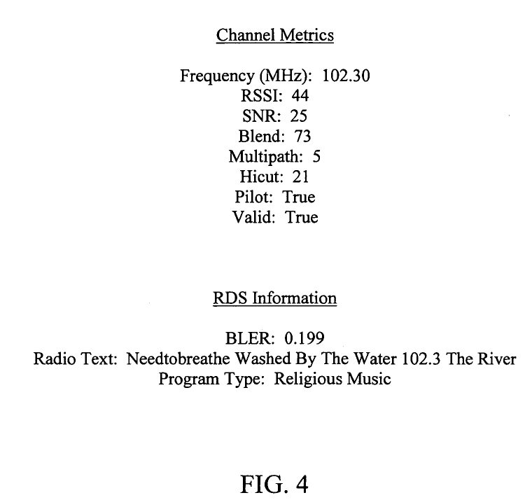

Still further, when a given selectable icon 210 is selected, understand that a table of performance and other data obtained at that data acquisition point may be displayed, e.g., in a sidebar or as an overlay on map 200. Referring now to FIG. 4, shown is a graphical view of a text box that may be displayed upon selection of such a selectable icon. As shown, various performance data obtained from the receiver may be shown, including channel metric data such as frequency, RSSI, SNR, mono/stereo blend, multi-path level, high cut level and additional information. Still further, GPS data, including a GPS-obtained timestamp may be shown. Additional data may be shown such as obtained via the demodulated signal. As seen, this information may include RDS data such as a program identifier, song information, radio station information, program type and so forth. Still further, at least one performance metric associated with the RDS data such as a block error rate (BLER) may also be provided. While shown with this particular implementation in the embodiments of FIGS. 3 and 4, understand that various displays of a route as well as different features can be realized in other implementations.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
recording performance data in a system, the performance data associated with a radio signal received by a broadcast receiver coupled to the system;
recording global positioning system (GPS) data in the system, the GPS data obtained from a GPS receiver co-located with the broadcast receiver; and
processing the performance data and the GPS data to map the performance data with the GPS data to indicate at least a location of the broadcast receiver and a corresponding receiver performance metric.

2. The method of claim 1, further comprising recording the radio signal in a recorder of the system.

3. The method of claim 1, wherein the processing includes formatting the performance data and the GPS data to generate information having a format compatible with a display application.

4. The method of claim 3, further comprising displaying the information on a display associated with the system using the display application, wherein the displaying includes providing a map view of an area in which the broadcast receiver was traveling and indicators to identify locations within the area at which the performance data was recorded.

5. The method of claim 4, wherein each of the indicators is selectable to display at least a portion of the performance data recorded at the corresponding location and to synchronize a playback of an audio signal obtained from the radio signal at the corresponding location.

6. The method of claim 5, further comprising displaying a table including at least the portion of the performance data as an overlay to at least part of the map view.

7. The method of claim 6, further comprising displaying a table including textual information obtained from demodulated data received by the broadcast receiver and further including at least one performance metric associated with the demodulated data.

8. The method of claim 1, wherein the performance data includes a signal strength of the radio signal and a signal-to-noise ratio of the radio signal, and the GPS data includes a location of the GPS receiver, and a heading at which the GPS receiver was traveling.

9. The method of claim 1, further comprising recording the performance data for a first broadcast receiver and a second broadcast receiver, and displaying at least a portion of the performance data for the first and second broadcast receivers on a display of the system, wherein the first and second broadcast receivers are of different manufacturers or include different firmware.

10. A system comprising:
a receiver to receive a radio frequency (RF) signal and to convert the RF signal into a demodulated signal and to generate performance data regarding the RF signal;
a global positioning system (GPS) receiver to receive a GPS signal and to generate GPS data therefrom; and
a computer system coupled to the receiver and the GPS receiver to receive the performance data and the GPS data obtained during traversal of a route on which the receiver and the GPS receiver travel and to process the performance data and the GPS data to map the performance data with the GPS data to indicate at least a location of the receiver and a corresponding receiver performance metric.

11. The system of claim 10, wherein the computer system is to record the demodulated signal.

12. The system of claim 10, further comprising a test equipment coupled to a calibrated antenna to receive the RF signal, wherein the test equipment is to generate at least one signal performance metric based on the RF signal.

13. The system of claim 10, further comprising a file generator to generate a file including a plurality of entries each including the GPS data and the performance data for a data acquisition point along the route.

14. The system of claim 13, wherein the computer system includes a mapping application to cause a display of the route and selectable markers along the route each corresponding to a data acquisition point.

15. The system of claim 14, wherein the mapping application is to display at least a portion of the performance data recorded at the data acquisition point in a table included as an overlay to at least part of the route display, and to enable synchronized playback of recorded audio data obtained from the receiver for the data acquisition point.

16. The system of claim 10, further comprising a second receiver coupled to the computer system to receive the RF signal, the second receiver configured differently from the first receiver and to convert the RF signal into a second demodulated signal and to generate performance data regarding the RF signal, and wherein the computer system is to receive and process the second receiver performance data and to associate the second receiver performance data with the performance data and the GPS data.

17. A system comprising:
a processor to execute instructions;
a storage medium including instructions that enable the system to receive performance data associated with a radio frequency (RF) signal received in a receiver coupled to the system and global positioning system (GPS) data received in a GPS receiver coupled to the system for traversal of a route on which the receiver and the GPS receiver travel, associate the performance data with the GPS data, generate a file including a plurality of entries each including the GPS data and the performance data for a data acquisition point along the route, and enable display of the route and selectable markers along the route, each of the selectable markers corresponding to a data acquisition point; and
a display to display the route and the selectable markers.

18. The system of claim 17, wherein the system includes an audio recorder to record an audio signal received from the receiver, the audio signal generated in the receiver from the RF signal, wherein playback of the audio signal is to be synchronized with regard to the data acquisition points.

19. The system of claim 17, further comprising instructions to enable the system to format the performance data and the GPS data to generate the file having a format compatible with a display application, and display the file on the display, wherein the display of the route includes a map view of an area in which the receiver was traveling.

20. The system of claim 17, further comprising a test equipment coupled to a calibrated antenna to receive the RF signal, wherein the test equipment is to generate at least one signal performance metric based on the RF signal and to provide the signal performance metric to the system for association with the performance data.
